(19) United States
(12) Patent Application Publication
(10) Pub. No.: US 2010/0190375 A1
(43) Pub. Date: Jul. 29, 2010

(54) CONNECTOR RECEPTACLE WITH MOLDED FRONT NUT GASKET

(76) Inventor: Daniel F. Rohde, Mechanicsburg, PA (US)

Correspondence Address: Tyco Electronics Technology Resources/;Brinks Hofer Gilson & Lione, 4550 New Linden Hill Road, Suite 140, Wilmington, DE, 19808, US

(21) Appl. No.: 12/360,502

(22) Filed: Jan. 27, 2009

(51) Int. Cl. H01R 13/73

(52) U.S. Cl. 439/549; 439/557

(57) ABSTRACT

A connector receptacle for insertion in a panel is disclosed. The connector has a threaded portion, and a compression stop. A gasket material is molded on a flange of the body of the receptacle such that at least a portion of the gasket material is compressible between the flange and the panel when the connector is installed. A fluid-tight seal is achieved when a compression stop is in contact with the panel.

### TECHNICAL FIELD

The present application relates to a panel-mounted cable interface.

### BACKGROUND

External connections to electrical, electronic and optical equipment may be made using mating connectors. An external cable, which may be an electrical cable of conductive wires, an optical cable having an optical fiber transmission path, or a combination of such techniques may mate with the equipment using a panel mounted interface part. The terminology used to describe the mating parts varies; however, the terms “jack” and “plug” corresponding to “female” and “male” parts is often used.

Alternatively the term “receptacle” is used instead of jack. Examples of hermaphrodite connector types are also known.

Panel-mounted connector receptacles are assembled from a plurality of parts so as to captivate a receptacle to a panel. For some equipment applications, such as in equipment having medical uses, the panel mounted connector receptacles may need to meet a particular specification for sealing, so as to exclude fluids from the interior of the equipment. This may prevent damage to the equipment from fluids encountered during the use of the equipment or the cleaning thereof. An O-ring or a flat washer made of resilient material may be disposed between a nut or flange of the receptacle and either a front (exterior) or rear (interior) surface of a panel to which the receptacle is mounted so as to form a compression seal between the receptacle body and the panel.

For example, the ODU Mini Snap OC receptacle (available from ODU USA, Camarillo, Calif.) intended for use in medical applications is watertight when mounted to the panel such that when the receptacle is mounted to the panel, a flat washer is disposed between a flange of the receptacle and the panel. The Alden PL500SM-N receptacle (available from

Alden Products Company, Brockton, Mass.) is mounted to a panel such that an O-ring fitted over a connector body of the receptacle may be compressed to a rear surface of the panel when the receptacle is mounted to the panel so as to achieve a watertight seal. A similar approach where the sealing O-ring is compressed against the front surface of the panel is disclosed in U.S. Pat. No. 3,613,048 to Brundza.

### SUMMARY

A device for installation in a panel is described, the device including a gasket adapted to be compressed against a panel, and a compression stop sized and dimensioned so that the force with which the gasket is compressed against the panel is regulated.

In an aspect, a connector receptacle for insertion in a panel may include a body having a substantially circular cross section that is threaded along a portion of an exterior surface of the body. The body may have a flange with a compression stop protruding from the flange and a gasket molded to the body that is disposed on the flange so as to have a portion facing in a direction of the threaded portion of the exterior surface of the body.

A method penetrating a panel includes providing a connector receptacle having a form factor suitable for insertion through an aperture in a panel, the connector receptacle having a molded gasket. A portion of the gasket extends outward from a face of a flange of the receptacle a distance further than that of a compression stop extending outward from the flange.

The connector receptacle may be inserted into the aperture, and captivated to the panel using a nut threaded onto the connector receptacle, so that a portion of the gasket is compressed between the flange and the panel. A fluid tight seal is achieved when the compression stop contacts the panel.

### BRIEF DESCRIPTION OF THE DRAWINGS

FIG. 1 is a side view of a receptacle mounted to a panel, and an associated connector plug positioned so as to be aligned with, but disengaged from, the receptacle;

FIG. 2 shows an exploded view of the receptacle, a panel to which it is mountable, and a captivating nut;

FIG. 3 is a cross sectional view of the receptacle as captivated to the panel;

FIG. 4 is a detail of FIG. 3 showing the relationship of the gasket and the flange, when the receptacle is mounted to the panel; and

FIG. 5 is a further detail of the gasket of FIG. 4, in the state where the flange is separated from the mounting panel.

### DETAILED DESCRIPTION

Exemplary embodiments of the invention may be better understood with reference to the drawings, but these embodiments are not intended to be of a limiting nature. Like numbered elements in the same or different drawings perform equivalent functions. When a specific feature, structure, or characteristic is described in connection with an example, it will be understood that one skilled in the art may effect such feature, structure, or characteristic in connection with other examples, whether or not explicitly stated herein.

A device, which may be a connector receptacle having a front flange with a molded gasket, may be configured so as to control the amount of compression of the gasket when the receptacle is captivated to a panel.

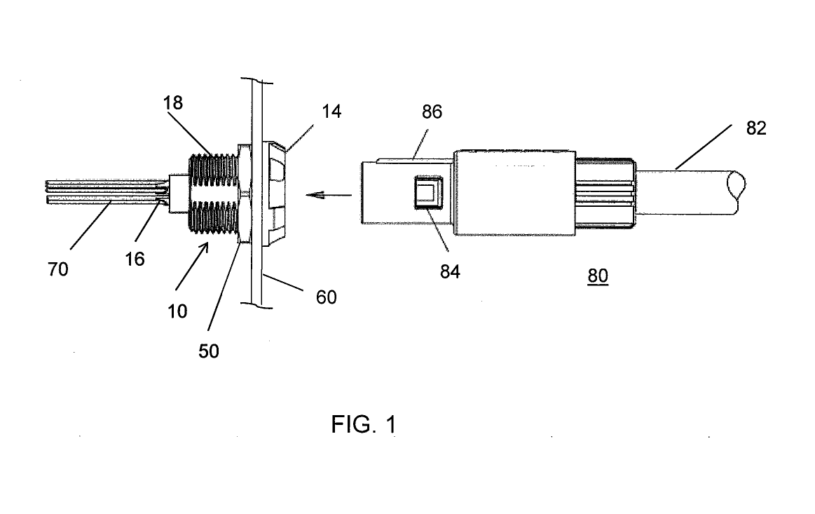

FIG. 1 shows a side view of a connector receptacle 10, the receptacle 10 being mounted to a panel 60. The receptacle 10 is captivated to the panel 60 by a nut 50, which may be, for example, a hex nut which is threaded onto the threads 18 of a body 15 of the receptacle 10, so as to draw a front portion 14 against the panel 60. An electrical connector type is shown. A plurality of wires 70 may be soldered to solder cups 16 at the rear of the receptacle 10. Alternatively, the wires 70 may be terminated fixtures that may be inserted into the receptacle 10, and positioned so as to engage pins (not shown) of the plug 80.

The plug 80 may terminate a cable 82 having wires, and configured so that the wire termination pins are facing the receptacle 10, as shown by the arrow. The plug 80 may also have a structure 86 which may be used as a key to align the pins of the plug with the corresponding mating elements of the receptacle 10. A latch 84 may be provided to positively engage the plug 80 and receptacle 10 so that the electrical and physical connection is maintained during the use of the equipment. The arrangement may be configured so that the plug and jack may be disengaged by applying a sufficient force to the plug 80 in an opposite direction to that of the arrow. Various methods of providing for engagement and disengagement of the plug and jack are known in the art, and the example here is merely to place the remainder of the discussion in context.

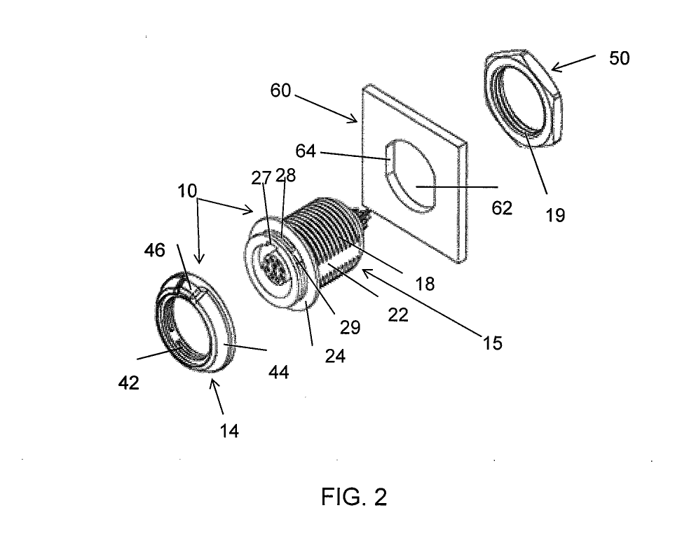

An exploded perspective view of the receptacle 10 in relation to the panel 60 is shown in FIG. 2. An aperture 62 is formed in the panel 60, and may have one or more flat segments 64, so as to engage with a corresponding flat portion 22 on the substantially circular cross section of the body 15 so that the flat segments 64 and the flat portions 22 cooperate to restrain the receptacle 10 from rotating in the aperture 62 when a torsional force is applied to the receptacle 10: for example, by a manipulation of the plug 80.

A flange 24 may be positioned between the threaded portion 18 and a ridged portion 28 of the receptacle body 15. The flange 24 performs the function of a front nut, being a portion of the arrangement for captivating the receptacle body 15 to the panel 60. A gasket portion 14 may be molded on a front portion of the receptacle body 15 such that grooves 42 in the gasket portion 14 are formed to engage with ridges 28 formed in the front portion of the receptacle body 15 as a circumferential ring. The ridges 28 and grooves 42 may not be continuous around the circumference of the receptacle. In an aspect, the ridges may be on the gasket portion 14 and the grooves may be on the receptacle body 15. The gasket may have a decorative portion 44, which may have a feature 46 molded therein so as to indicate the position of a key groove 27 which is intended to mate with the key 86 on the plug 80, so as to align the plug 80 and the receptacle 10 during the course of inserting the plug 80 in the receptacle 10.

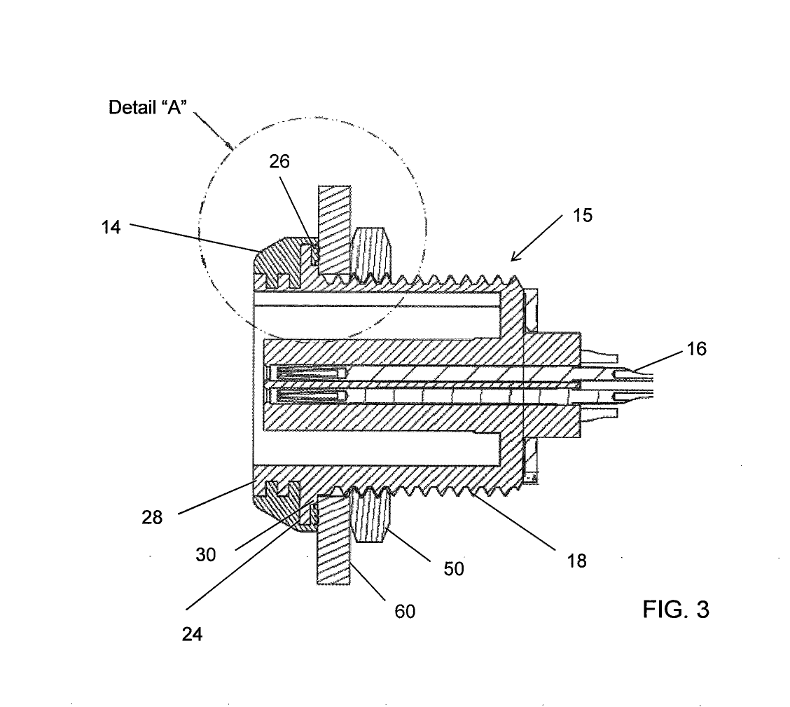

FIG. 3 shows the receptacle 10 installed into a panel 60, where the nut 50 has been tightened so as to compress a portion 26 of the molded gasket 14 between the flange 24 and the panel 60.

Further details of the molded gasket 14 are seen in a cross sectional view of FIG. 3. The gasket 14 and the receptacle body 15 are shown in a state where the gasket 14 has been molded on the receptacle body 15 to form an integral assembly 10. A flange 24 and a compression stop 30 of the receptacle body 15 may be disposed so that the portion 26 of the gasket may be positioned between the flange 24, and the panel 60 through which the receptacle 10 may be inserted for installation purposes.

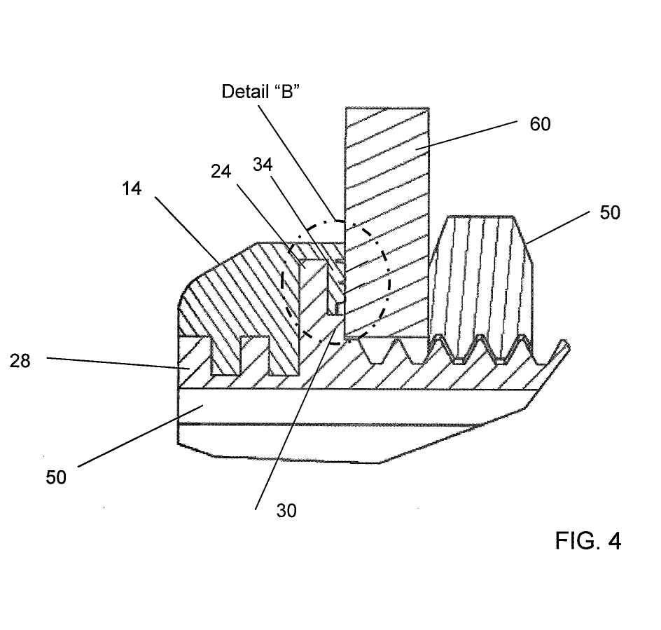

As may be seen in FIG. 4, which shows detail A of FIG. 3, the portion 26 of the gasket 14 that is disposed on the face of the flange 24 is positionable so as to oppose the panel 60 to which the receptacle 10 is to be mounted has one or more circumferential bosses 34 positioned so that the bosses would be compressed against a panel 60 when the receptacle 10 is installed, and the nut 50 is threaded onto the threads 18 of the receptacle and tightened. The amount of compression of the bosses 34 when the receptacle 10 is captivated to the panel 60, is controlled by the gap distance G, which is the distance by which the surface of the boss portions 34 of the gasket portion 26 projects outward from the flange 24 towards the panel 60 further than the compression stop 30 projection from the flange 24. The compression stop 30 is sized and dimensioned so that the gasket 26 is compressed against the panel 60 with a force sufficient to achieve the desired fluid-excluding properties when the compression stop 30 comes in contact with the panel 60.

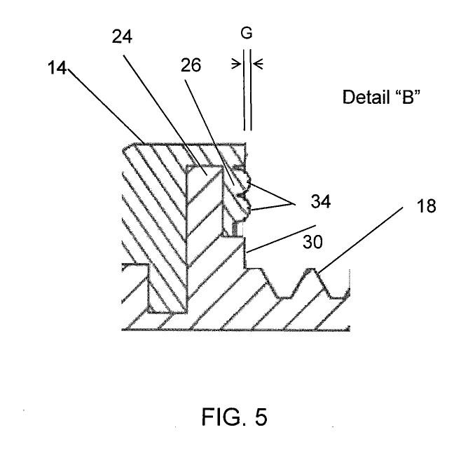

The details of the arrangement of the bosses 34 with respect to the flange 24 and a face of the stop 30 is shown in FIG. 5, in a state where the receptacle body 15 is not captivated against the panel 60, and the bosses 34 are not compressed.

When the receptacle 10 is installed in the panel 60, and the nut 50 is tightened, the gasket 14 and, the boss 34 may deform and contact the surface of the panel 60 with a predetermined amount of force. While the nut 50 may be torqued to a particular specification, which may be, for example, about 33 inch pounds, the distance between the face of the stop 30 and the panel 60 is determined geometrically. The pressure of the contact between the gasket 14 and the panel 60 is intended to provide a fluid-excluding seal, which may be designed to meet an industry specification, such as ANSI/IEC 60529-2004, Ingress Protection (IP) Environmental Rating IPX6, powerful water jets (National Electrical Manufacturers Association, Rosslyn, Va.), or other specification or requirement for fluid exclusion. Such requirements for fluid exclusion in medical equipment may be for sanitary reasons, so that the equipment may be cleaned or disinfected by hospital personnel without damage to the electronics or other components within the equipment.

In another aspect, the plug 80 may terminate an optical fiber, such as may be used for data communications, or a light pipe. Receptacles for other purposes, such as fluidics, may be mounted and sealed in a similar manner. In such applications, the term “cable” would be understood to mean a light wave structure such as an optical fiber or light pipe, or a tube for containing fluid.

The receptacle body 10 may be made from a metal suitable for such connectors such as aluminum or die cast zinc, or a molded plastic such as a polyimide thermoplastic resin, ULTEM (available from Sabic Innovative Plastics, Niskayuna, N.Y.), polycarbonate, LEXAN (Sabic Innovative Plastics), or the like. The gasket material may be any suitable moldable material, such as thermoplastic elastomer (TPE), e.g., SANTOPRENE 291-60B 150 (available from Exxon Mobile Chemical, Houston, Tex.), or the like. The TPE has a Shore hardness of approximately 60. The material is available in colors.

In another aspect, the gasket may be co-molded using more than one type of material and configured such that the material in the outward facing portion of the gasket region 14, which remains exposed after installation is fabricated from a material having properties selected for durability rather than the function of being a gasket material. This may also permit color coding the visible surface of the receptacle.

Although the present invention has been explained by way of the examples described above, it should be understood to the ordinary skilled person in the art that the invention is not limited to the examples, but rather that various changes or modifications thereof are possible without departing from the spirit of the invention. Accordingly, the scope of the invention shall be determined only by the appended claims and their equivalents.

What is claimed is:

1. A device for installation in a panel, comprising:
a gasket adapted to be compressed against a panel; and
a compression stop sized and dimensioned so that the force with which the gasket is compressed against the panel is determined.

2. The device of claim 1, wherein the compression stop contacts the panel when the device is installed.

3. The device of claim 1, further comprising:
a body having a substantially circular cross section, the body having a threaded portion, and having a flange with the compression stop;
wherein the gasket is molded to the body and disposed on the flange so as to have a portion facing in a direction towards the threaded portion.

4. The device of claim 3, wherein a portion of the body on an opposite side of the flange from the threaded portion has a circumferential ring, the gasket being molded over at least a portion of the ring.

5. The device of claim 4, having a plurality of circumferential rings, spaced apart, wherein at least one of the circumferential rings has a gap.

6. The device of claim 3, wherein the portion of the body on an opposite side of the flange from the threaded portion has a circumferential groove, the gasket being molded over the groove.

7. The device of claim 3, wherein the gasket portion facing the threaded portion is formed so as to have a circumferential boss thereon.

8. The device of claim 7, wherein a surface of the boss projects outward from the flange a distance greater than a distance that the compression stop projects outward from the flange.

9. The device of claim 8, wherein the projection distance of the boss and the projection distance of the compression stop are selected such that, when the device is inserted in the panel, and is captivated to the panel by a nut engaging the threaded portion, the gasket contacts the panel so as to form a fluid-excluding seal.

10. The device of claim 9, wherein the fluid-excluding seal meets the requirements of ANSI/IEC 60529 (Ingress Protection Rating, IPX6).

11. The device of claim 10, wherein the nut is torqued to a specified value during installation of the device to the panel.

12. The device of claim 3, wherein the gasket is a thermoplastic rubber.

13. The device of claim 3, wherein the gasket is molded with a material having a greater hardness than that of the gasket.

14. The device of claim 3, wherein the gasket is molded with a material of a different color.

15. The device of claim 3, wherein the body has a receptacle suitable for receiving a plug.

16. The device of claim 15, wherein the plug is a male electrical connector.

17. The device of claim 15, wherein the receptacle is configured to mate with a plug.

18. The device of claim 15, wherein the receptacle is a fiber optic connector.

19. The device of claim 18, wherein the receptacle is configured to mate with a fiber optic connector.

20. The device of claim 15, wherein the receptacle and the plug have a keying structure, and the gasket has an indicator segment oriented along a circumference thereof corresponding to a location of a receptacle keying structure.

21. The device of claim 1, wherein the compression stop is disposed adjacent to a body of the device.

22. The device of claim 1, wherein the gasket is compressed against a front surface of the panel.

23. A method of penetrating a panel, the method comprising:
providing a connector receptacle having a form factor suitable for insertion through an aperture in the panel, the connector receptacle having a gasket molded thereto, a portion of the gasket extending outward from a face of a flange of the connector receptacle a distance further than that of a compression stop extending outward from the flange;
inserting the connector receptacle into the aperture,
captivating the connector receptacle to the panel so that a portion of the gasket is compressed between the flange and the panel.

24. The method of claim 23, wherein a fluid-excluding seal is formed between the connector receptacle and the panel when the compression stop contacts the panel.

25. The method of claim 23, wherein the distance is selected so that the seal between the gasket and the panel meets ANSI/IEC 60529 (Ingress Protection Rating, IPX6).
